(19) United States
(12) Patent Application Publication
(10) Pub. No.: US 2018/0204245 A1
(43) Pub. Date: Jul. 19, 2018

(54) INFERENTIAL TARGETED ADVERTISING

(71) Applicant: International Business Machines Coporation, Armonk, NY (US)

(72) Inventor: Kirk J. Krauss, Los Gatos, CA (US)

(21) Appl. No.: 15/406,954

(22) Filed: Jan. 16, 2017

(51) Int. Cl. G06Q 30/02

(52) U.S. Cl. CPC G06Q 30/0255; G06Q 30/0204

(57) ABSTRACT

A processor-implemented method for determining interest levels with respect to items displayable by a user interface is provided. The method includes determining a user classification of a user browsing via the user interface the items. The method further includes determining a first interest level in a first item of the items and a second interest level in a second item of the items. The first item is associated with a first category. The second item is associated with a second category. The method includes determining a first relationship between the first item and a third item and a second relationship between the second item and the third item. The method also includes determining a third interest level in a third item of the items based on the user classification, the first relationship, and the second relationship.

### BACKGROUND

The disclosure relates generally to inferential targeted advertising, and more specifically, to inferring interest levels for items across disjointed categories.

In general, conventional advertising mechanisms can provide targeted advertising solutions that infer a person's interests based on the interests of members of that person's social network (e.g., a person who belongs to a hiking interest group may have an interest in hiking equipment) or a historically-oriented analysis of item selections (e.g., a person who has purchased a hiking tent may have an interest in a hiking backpack). However, these targeted advertising solutions rely on certain data and history involving just a category of items and include no insight into a person's interest in products of other disjointed categories. For example, conventional advertising mechanisms fail to provide targeted advertising solutions that infer an interest for one product (e.g., energy-efficient appliances) based on an interest in another, different type of product (e.g., hiking equipment).

### SUMMARY

According to one or more embodiments, a processor-implemented method for determining interest levels with respect to a plurality of items displayable by a user interface is provided. The processor-implemented method includes determining a user classification of a user browsing via the user interface at least a portion of the plurality of items and determining a first interest level in a first item of the plurality of items, the first item being associated with a first category. The processor-implemented method includes determining a second interest level in a second item of the plurality of items, the second item being associated with a second category, and determining a first relationship between the first item and a third item. The processor-implemented method includes determining a second relationship between the second item and the third item. The processor-implemented method also includes determining a third interest level in a third item of the plurality of items based on the user classification, the first relationship, and the second relationship.

According to one or more embodiments, the inferential system described herein can be implemented as a system and/or a computer program product.

Additional features and advantages are realized through the techniques of the present disclosure. Other embodiments and aspects of the disclosure are described in detail herein. For a better understanding of the disclosure with the advantages and the features, refer to the description and to the drawings.

### BRIEF DESCRIPTION OF THE DRAWINGS

The subject matter is particularly pointed out and distinctly claimed in the claims at the conclusion of the specification. The foregoing and other features, and advantages of the embodiments herein are apparent from the following detailed description taken in conjunction with the accompanying drawings in which:

FIG. 1 depicts a process flow of an inferential system in accordance with one or more embodiments of the present invention;

FIG. 2 depicts a process flow of an inferential system in accordance with one or more embodiments of the present invention;

FIG. 3 depicts a process flow of an inferential system in accordance with one or more embodiments of the present invention;

FIG. 4 depicts a process flow of an inferential system for scoring criteria for user interest level in accordance with one or more embodiments of the present invention;

FIG. 5 depicts a process flow of an inferential system for scoring criteria for item classification in accordance with one or more embodiments of the present invention;

FIG. 6 depicts a process flow of an inferential system for selecting an item to advertise in accordance with one or more embodiments of the present invention; and

FIG. 7 illustrates a processing system in accordance with one or more embodiments of the present invention.

### DETAILED DESCRIPTION

In view of the above, embodiments of the present invention described herein include an inferential targeted advertising system, method, and/or computer program product (herein an inferential system) that infers interest levels for items across disjointed categories. In operation, the inferential system can, based on a first interest level of a user in an item of a first category, infer a subsequent interest level of the user in a subsequent item of a disjointed category to provide that subsequent item in a suggested advertisement by determining a relationship across these categories.

For example, the inferential system can determine that a user has a high interest level in hiking boots in a hiking equipment category. The inferential system can infer that hiking equipment category purchases indicate that the user is environmentally conscious. The inferential system can then assess a disjointed category, such as home appliances, and determine that the user will have a high interest level in items of this category that reduce a carbon footprint, such as energy-efficient refrigerators. That is, the inferential system can determine a relationship between items of the disjoint home appliance and hiking equipment categories to suggest an energy efficient refrigerator within a targeted advertisement to the user.

Embodiments of the inferential system described herein are necessarily rooted in one or more processors to perform proactive operations to overcome problems specifically arising in the realm of targeted advertising. In this way, technical effects and benefits of the inferential system described herein include enabling related items across disjointed categories to be suggested to users who otherwise would never receive the suggestions. Note that the suggestions of the items in disjointed categories are unavailable in (and thus an improvement on) conventional advertising mechanisms.

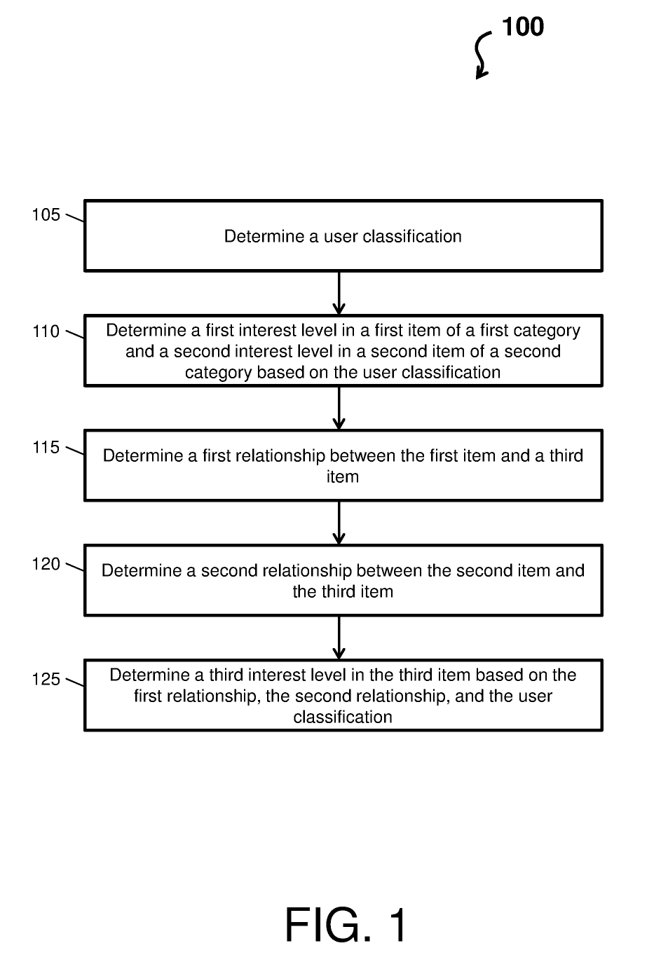

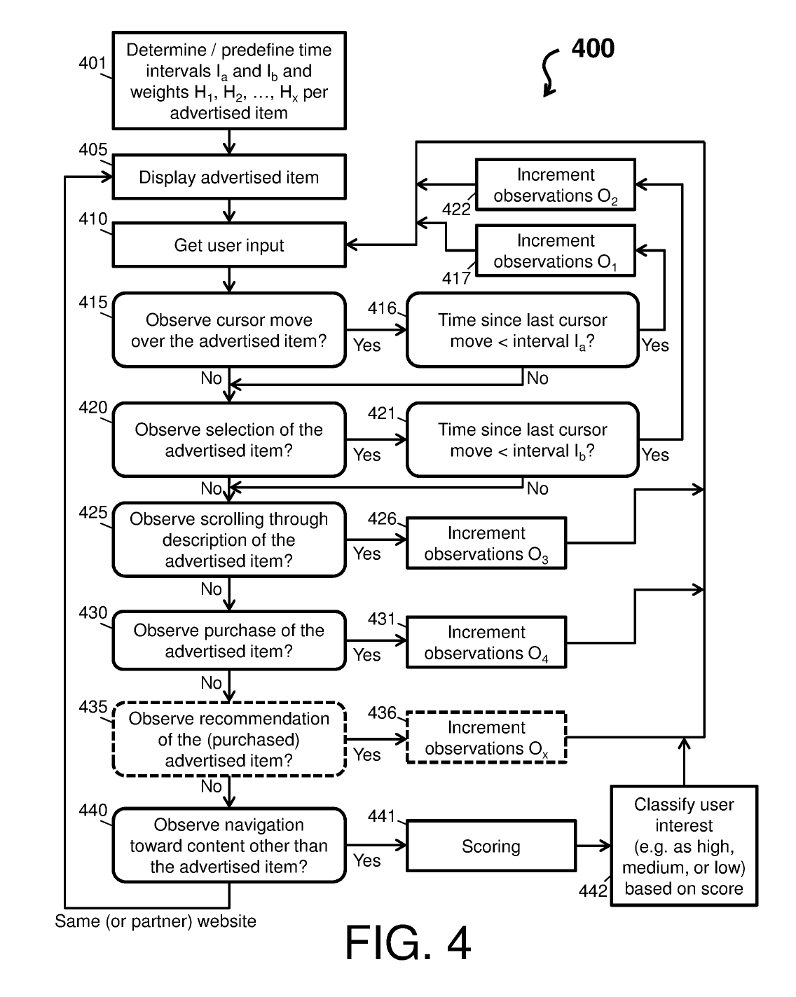

Turning now to FIG. 1, a process flow 100 is generally shown as an example inferential targeted advertising operation of the inferential system in accordance with one or more embodiments of the present invention. The inferential system can be an electronic, computer-implemented framework comprising and/or employing any number and combination of processing systems (e.g., as described with respect to FIG. 4), software systems, and networks utilizing various communication technologies, as described herein. The inferential system also can comprise a processor and/or a set of memory-resident program instructions executable thereon. The program instructions executable by the processor cause the inferential system to perform operations, such as those described by the process flow 100.

In a non-limiting embodiment, the inferential system can reside on a World Wide Web (herein “web”) server and/or a file system accessible via the Internet. Data of the web server and data available within the file system are accessed by a user device (e.g., a desktop computer, a smartphone, a remote terminal, etc.). In turn, the inferential system can monitor incoming and outgoing traffic between the user device, the web server, and/or the file system. Components of the inferential system also can reside on one or more further user devices to monitor incoming and outgoing traffic between the user devices, the web server, and/or the file system, for multiple users. The incoming and outgoing traffic can comprise website selections, item selections, link selections, etc., each of which indicates user behavior.

The process flow 100 begins at block 105, where the inferential system determines a user classification. The user classification can be determined by the inferential system for each user who interacts with at least a portion of a plurality of items displayable by a user interface.

The plurality of items can include goods (e.g., tangible objects) and services (e.g., acts provided by a third party). Note that at least the portion of the plurality of items can be advertised by one or more primary advertisers, such as vendors, merchants, and websites. The plurality of items can be associated with one or more categories and/or sub-categories. Examples of the item categories and/or sub-categories include but are not limited to electronics, office products, movies, music, books, furniture, patio furnishings, home improvement products, clothing, shoes, jewelry, baby and toddler supplies, toys, video games, food, household goods, pet supplies, pharmaceuticals, health, sports, fitness, beauty, and outdoor items, tires, automobiles, photos, gifts, consumer products, services, investments, real estate, group memberships, information feeds, garden equipment, hiking equipment, tools, seasonal clothing, accessories, etc. The categories and/or sub-categories can comprise disjointed categories that represent two or more dissimilar vendors, merchants, and/or websites (e.g., not identical to one another). Disjointed categories can also describe items of different types that are advertised by a common vendor, merchant, and/or website.

Generally, the user interface is a software application, such as a web browser, a browser-based application, or a mobile application, of a user device. The user interface is utilized to support interactions between one or more user devices and the Internet, as directed by each user. Thus, the inferential system can monitor these interactions, based on incoming and outgoing traffic, to determine the user's level of interest in one or more items or item categories and deduce the user classification from those interest levels.

The user classification can be deduced or determined from a plurality of designated classifications. In a non-limiting embodiment, the plurality of designated classifications is predetermined during a configuration operation of the inferential system by a user (e.g., a software designer or administrator). Examples of the plurality of designated classifications include risk-averse, risk-tolerant, bargain shopper, high-end or Epicurean shopper, knowledge-based consumer, casual shopper, impulse shopper, etc. Examples of the plurality of designated classifications also include combined classifications such as a cautious earth-friendly homeowner, an adventurous comfort-driven homeowner, an adventurous cost-limited renter, and a cautious cost-limited renter.

In a non-limiting embodiment, a database comprising hardware and/or software can store user classifications of websites with respect to item categories that are used to drive the inferential system. Some sample user classifications, based on products the users commonly shop for and purchase, can include: a home improvement website that classifies a user as a homeowner (interested in major appliances, fixtures, and heavy gardening equipment) or a renter (interested in duct tape and pocket screwdrivers); a music website that classifies users as traditionalist (interested in classical, oldies, and traditional folk choices) or contemporary listener (interested in rock, rap, and techno choices); a movie website that classifies users as thrill seekers (interested in psychological thrillers and action films) or Epicureans (interested in romantic comedies, foreign films, and documentaries); a wholesale website that classifies users as guarded planners (interested in bulk necessities) or adventurous people (interested in robotic vacuum cleaners and imported dry goods); a personal items site that classifies users as earth conscious (interested in recycled toiletries, organic foods, and nutritional supplements), as comfort-driven (interested in brand-name products), and as cost-limited (interested in bargain basement toiletries and generic drugs).

The inferential system can determine a plurality of interest levels, where each level corresponds to one of the plurality of items. Returning to the process flow 100, at block 110, the inferential system determines a first level of interest (also referred to as a first interest level) in a first item of a first category and a second level of interest (also referred to as a second interest level) in a second item of a second category. Determining one or both of the first and second interest levels can include observing user behavior within the user interface with respect to the first and second items (e.g., monitoring incoming and outgoing traffic between the user devices, the web server, and/or the file system).

To observe user behavior, the inferential system can utilize cookies and/or timers on the user device to provide information. A cookie can be software and/or data stored on a user device or computer by the user interface while the user is browsing. A timer can be hardware, software, or a combination thereof that can count increments within a time interval. Examples of information provided by the cookies and/or timers include data with respect to a length of time a cursor hovers over an item, a number of times the cursor has returned to an item, a number of times the user has clicked an item and/or a similar item, and whether a description of an item was scrolled through (i.e., indicating that the user read the description). In a non-limiting embodiment, the observing of user behavior within the user interface can include utilizing one or more timers with respect to a length of time a cursor hovers over a first item and storing cookies with respect to a number of times the cursor has returned to the first item. Note that the first category and the second category can overlap (e.g., a hiking equipment sub-category within an outdoors category), can be the same category, or can be disjoint categories.

At block 115, the inferential system determines a first relationship between the first item and a third item. At block 120, the inferential system determines a second relationship between the second item and the third item. Relationships between items are inferred connections based on user classification (e.g., criteria for classifying a user based on behavior) and other information. The other information can be determined directly based on browsing history as monitored by the inferential system, purchase history of the items, usage of mobile applications with respect to the items, and based on descriptions and reviews of the items, as well as on operations for choosing an advertisement for display.

At block 125, the inferential system determines a third level of interest (also referred to as a third interest level) in the third item based on the first relationship, the second relationship, and the user classification. In a non-limiting embodiment, the third item is of a third category that is different from at least one of the first and second categories (e.g., the third category is disjointed from the first and/or second category). Note that the first relationship and the second relationship can be determined across the first and second categories with respect to the third category. Once identified, the third item can then be provided in an advertisement via the user interface, such as by delivering one or more advertisements by displaying the third item in a personalized banner. The advertisement of the third item can be provided by a subsequent advertiser that is different from the one or more primary advertisers of the at least the portion of the plurality of items (e.g., the primary advertisers are not identical to the subsequent advertiser).

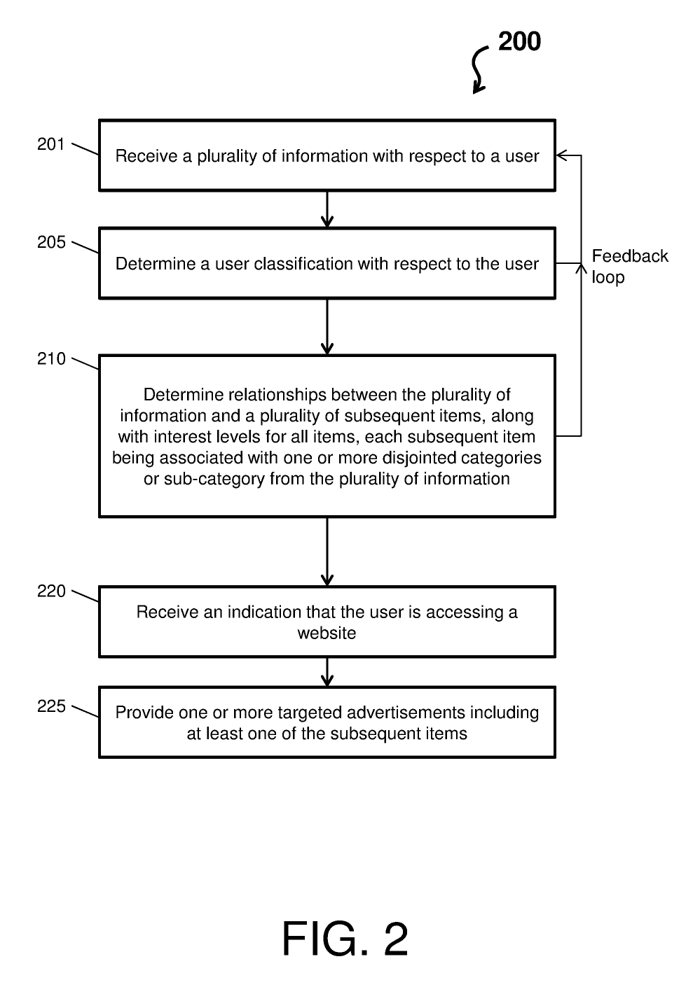

Turning now to FIG. 2, a process flow 200 is generally shown as an example inferential targeted advertising operation of the inferential system in accordance with one or more embodiments of the present invention. As described herein, the inferential system can comprise program instructions executable by a processor to cause the inferential system to perform operations, such as those described by the process flow 200.

The process flow 200 begins at block 201, where the inferential system receives a plurality of information. The plurality of information can include one or more items, one or more item categories, and a plurality of designated item classifications, all of which can be directly provided by merchants, farmed by the inferential system from the Internet, and/or manually input by the user (e.g., software designer or administrator). Note that each item can be associated with one or more item categories.

For example, a first website (Site A) can be an online retailer's website. Site A offers for sale an array of items, as described herein, from which a user can choose, and Site A provides information associated with those items. In a non-limiting embodiment, a first item can be a robotic vacuum cleaner associated with a first category, such as an appliance category. A second item can be a solid wooden dining table associated with a second category, such as a home furniture category. A third item can be a generic paper towel dispenser associated with a third category, such as household essentials. In a very simple embodiment, described herein as an example for clarity, a one-time purchase of one of these items may allow for a user classification that drives a subsequent targeted advertising determination. Those skilled in the art will recognize that ongoing observations of user behavior may better serve for user classification in a real-world embodiment.

The process flow 200 proceeds to block 205, where the inferential system determines a user classification. User classifications can be determined over time with respect to the inferential system monitoring Internet conduct and behavior. As indicated herein with respect to observing user behavior, Internet conduct and behavior can include interactions between users and the Internet, such as which websites are visited, which items are purchased, which articles are browsed, which games are played, etc. For instance, over the course of three months, if the Internet conduct and behavior of a particular user includes purchasing a set of items, then the one or more categories of each item of the set of items can be used to deduce a user classification from a plurality of designated classifications. Note that user classifications can be long-term classifications, such that once a user classification is established for a particular user, that user classification can be utilized repeatedly over time for that user or can be updated based on further observations of the user's behavior.

In a non-limiting embodiment, the inferential system can infer that a user who purchases the robotic vacuum cleaner from Site A can be relatively risk-tolerant or adventurous. That is, because product descriptions and reviews indicate that robotic vacuum cleaners may not work thoroughly, may damage other household items, may frighten children and pets, and may be more sophisticated than other vacuum cleaners, robotic vacuum cleaners can be classified as a risk-tolerant or adventurous item within the appliance category. In turn, users to whom robotic vacuum cleaners have an appeal can be considered people who take chances, and thus are observed to be risk tolerant. Users who are observed on one or more occasions to be risk tolerant according to one or more criteria may be classified as such.

Further, the inferential system can infer that a user who purchases the solid wooden dining table from Site A can be relatively risk-averse or cautious. That is, because product descriptions and reviews indicate that solid wooden dining tables may last a lifetime, may include high associated costs, may be purchased by people who do not often relocate from place to place, and may appeal to people who entertain family or guests, solid wooden dining tables can be classified as a risk-averse or cautious item within the home furniture category. In turn, users to whom solid wooden dining tables have an appeal can be considered people who lean in the direction of long-lasting items that retain their value, and thus are observed to be guarded planners. Users who are observed on one or more occasions to be guarded planners according to one or more criteria may be classified as such.

Furthermore, the inferential system can infer that a user who purchases the generic paper towels from Site A can be relatively cost conscious. That is, because product descriptions and reviews indicate that generic paper towels may perform the same as name brands and cost less, generic paper towels can be classified as a bargain item within the household essentials category. In turn, users to whom generic paper towels and other budget-priced items have an ongoing appeal can be considered people who only or primarily browse bargain-basement necessity items, and thus are determined to be bargain shoppers. Users who are observed on one or more occasions to be bargain shoppers according to one or more criteria may be classified as such.

At block 210, the inferential system determines relationships between the plurality of information and a plurality of subsequent items, along with interest levels for all items, each subsequent item being associated with one or more disjointed categories or sub-categories from the plurality of information.

The plurality of subsequent items can be items that were not evaluated at block 201 and 205, and thus can be considered additional items that a user can interact with at some future time (such as at block 225). For example, a second website (Site B) can be a bank's website. Site B seeks to advertise investment options directed to each user that visits the site. Each investment option can be one of the subsequent items associated with one or more categories. In a non-limiting embodiment, a relatively high-risk category can include investment options like stocks, derivatives, and stock-based funds. A relatively low-risk category can include investment options like money market funds and bonds. An entry-level investment category can include investment options like certificates of deposit and savings accounts.

Relationships between the plurality of information and the plurality of subsequent items are inferred connections based on user classifications and interest levels. For example, in a relatively simple and non-limiting embodiment the inferential system can associate a user with a risk-tolerant classification due to a purchase of the robotic vacuum cleaner from Site A (where, e.g., the purchase is taken to demonstrate high interest) indicative of an interest in expensive products whose value or life expectancy is speculative or short. From the bank's perspective, that user might prefer investment options in the relatively high-risk category, and thus the inferential system forms a relationship between the robotic vacuum cleaner and stocks, derivatives, and related funds.

Further, the inferential system can associate a user with a risk-averse shopper classification due to a purchase of the solid wooden dining table (e.g., the purchase is taken to demonstrate high interest) indicative of an interest in long-lasting items that retain their value. From the bank's perspective, that user might prefer investment options in the relatively low-risk category, and thus the inferential system forms a relationship between the solid wooden dining table and money market or bond funds.

Furthermore, the inferential system can associate a user with a bargain shopper classification due to a purchase of the generic paper towels (e.g., the purchase is taken to demonstrate high interest) indicative of an interest in bargain-basement necessity items. From the bank's perspective, that user might prefer investment options in the entry-level investment category, and thus the inferential system forms a relationship between the generic paper towels and savings accounts or certificates of deposit. In some embodiments, an ongoing nature of user behavior, such as repeating purchases of bargain-priced items as opposed to few or no purchases of higher-priced items, may drive the inferential system's user classifications and thus the choice of investment options advertised to a given user by the bank. In other embodiments, similar user classifications, based on either one-time or ongoing user behavior, can drive targeted advertising by entities other than banks.

Note that the process flow 200 can employ a feedback loop with respect to the plurality of information of block 201, the user classifications of block 205, and the interest levels of block 210 to maintain and update user classifications. In a non-limiting embodiment, the inferential system can include an agent (e.g., a computer program) that acts for the inferential system to maintain and update user classifications according to a user's ongoing Internet conduct and behavior.

At block 215, the inferential system receives an indication that the user is accessing a website. For example, to continue with the foregoing very simple embodiment, the website can be Site B. At block 225, the inferential system provides one or more targeted advertisements for at least one of the subsequent items. The subsequent items advertised by the targeted advertisements can correspond directly to the relationships of block 210. For each user/visitor to Site B, in the foregoing embodiment, the choice of which of the investment items to advertise can be determined based on each particular visitor's interest demonstrated with respect to Site A.

In a non-limiting embodiment, the one or more targeted advertisements can also be operated by the inferential system according to combined classification, such as when a user classified as an earth-conscious homeowner can see a targeted advertisement for environmentally-oriented bond funds; a user classified as a risk-tolerant homeowner can see a targeted advertisement for individual stocks of companies based in the neighborhood; a user classified as a risk-tolerant renter can see a targeted advertisement for stock funds; and a user classified as a cost-limited renter can see a targeted advertisement for entry-level savings accounts.

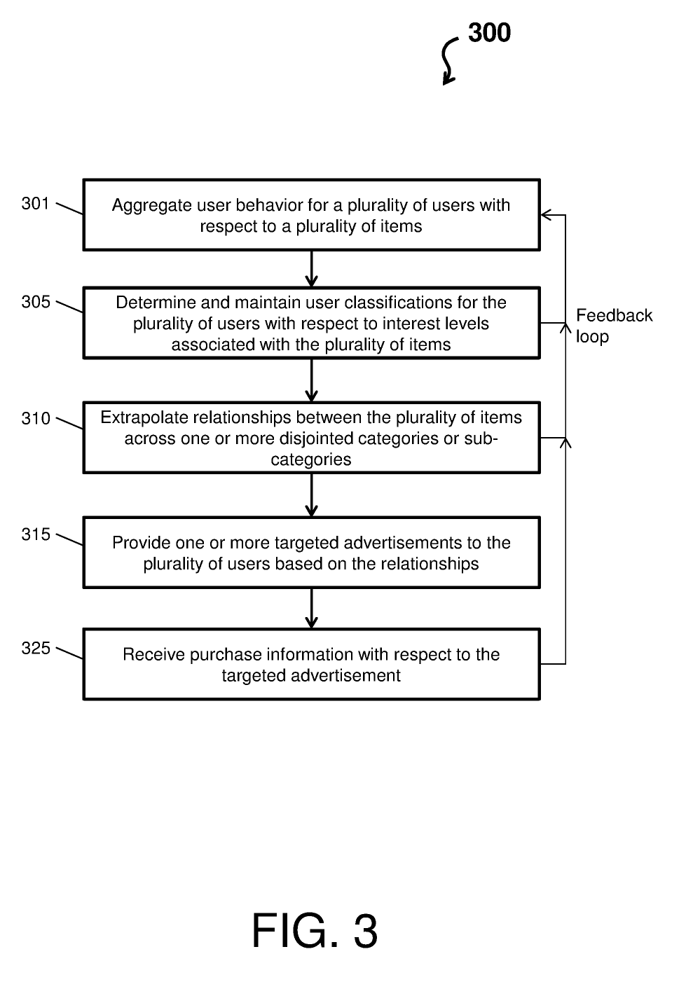

Turning now to FIG. 3, a process flow 300 is generally shown as an example inferential targeted advertising operation of the inferential system in accordance with one or more embodiments of the present invention. As described herein, the inferential system can comprise program instructions executable by a processor to cause the inferential system to perform operations, such as those described by the process flow 300. The process flow 300 begins at block 301, where the inferential system aggregates user behavior for a plurality of users with respect to a plurality of items.

At block 305, the inferential system determines and maintains user classifications for the plurality of users with respect to interest levels associated with the plurality of items. At block 310, the inferential system extrapolates relationships between the items across one or more disjointed categories or sub-categories.

At block 315, the inferential system provides one or more targeted advertisements to the plurality of users based on the relationships. At block 325, the inferential system receives purchase information with respect to the targeted advertisement.

Turning now to FIG. 4, a process flow 400 of an inferential system for scoring criteria for user interest level is depicted in accordance with one or more embodiments of the present invention. In this description of FIG. 4 and the subsequent figures, the term “inferential system” includes both a system for selecting targeted advertisements for display to a user and any associated systems, such as a web server, web browser, or other associated software or hardware, by which advertisements are actually displayed and by which user input, such as a browsing gesture or purchasing commitment, is received. The process flow 400 begins at block 401, where the inferential system determines (and/or utilizes predefined) time intervals Iₐ and I_{b} and weights H₁, H₂, . . . , Hₓ per advertised item of one or more advertised items. At block 405, the inferential system displays one or more advertised items. The inferential system, upon displaying the one or more advertised items, monitors user activity with respect to those items. For instance, at block 410, the inferential system gets user input. The user input can include cursor movement (navigation towards, away, or onto an item), time displayed (screen positioning), scrolling activity (navigation towards, away, or onto an item), etc. The inferential system, by monitoring user activity, can sequentially and/or simultaneously execute one or more inquiries that result in scoring criteria for user interest level for each of the one or more advertised items.

At decision block 415, the inferential system observes whether there is a cursor movement over a displayed advertised item (e.g., the one or more advertised items). If there is movement, the process flow 400 proceeds according to the Yes arrow to decision block 416. At decision block 416, the inferential system determines whether a time since a last cursor move is less than an interval Iₐ. If the last cursor move is less than the interval Iₐ, the process flow 400 proceeds according to the Yes arrow to block 417. At block 417, the inferential system increments a first observation count O₁, and the process flow 400 proceeds according to block 410 to gather more user input for the same displayed item or another item (e.g., of the one or more advertised items). If there is no movement or if the last cursor move is not less than the interval Iₐ at decision block 415, the process flow 400 proceeds according to the corresponding No arrows to decision block 420.

At decision block 420, the inferential system observes whether there is a selection of the displayed advertised item. If there is a selection, the process flow 400 proceeds according to the Yes arrow to decision block 421. At decision block 421, the inferential system determines whether a time since a last cursor move is less than an interval I_{b}. If the last cursor move is less than the interval I_{b}, the process flow 400 proceeds according to the Yes arrow to block 422. At block 422, the inferential system increments a second observation count O₂, and the process flow 400 proceeds according to block 410 to gather more user input for the same displayed item or another item (e.g., of the one or more advertised items). If there is no selection or if the last cursor move is not less than the interval I_{b} at decision block 420, the process flow 400 proceeds according to the corresponding No arrows to decision block 425.

At decision block 425, the inferential system observes whether there is a scrolling through the description of the displayed advertised item. If there is a scrolling, the process flow 400 proceeds according to the Yes arrow to block 426. At block 426, the inferential system increments a third observation count O₃, and the process flow 400 proceeds according to block 410 to gather more user input for the same displayed item or another item (e.g., of the one or more advertised items). If there is no scrolling at decision block 425, the process flow 400 proceeds according to the No arrow to decision block 430.

At decision block 430, the inferential system observes whether there is a purchase of the displayed advertised item. If there is a purchase, the process flow 400 proceeds according to the Yes arrow to block 431. At block 431, the inferential system increments a fourth observation count O₄, and the process flow 400 proceeds according to block 410 to gather more user input for the same displayed item or another item (e.g., of the one or more advertised items). If there is no purchase at decision block 430, the process flow 400 proceeds according to the No arrow to decision block 435 and/or block 440. That is, decision block 435 is representative of a plurality of inquires that can be included in the process flow 400 in addition to and/or in lieu of the inquiries discussed herein. Thus, decision block 435 and block 436 are shown as dashed-lined to represent the scalability of the process flow 400 (e.g., embodiments herein demonstrate real-world scalability more than may be achieved using direct item-item relationship determinations).

At decision block 435, the inferential system observes whether there is a recommendation, posted by the user, of the advertised item. In a non-limiting embodiment, this recommendation can be in conjunction with the purchase of block 430 during a subsequent data gathering loop. If there is a recommendation, the process flow 400 proceeds according to the Yes arrow to block 436. At block 436, the inferential system increments at least one subsequent observation count Oₓ, and the process flow 400 proceeds according to block 410 to gather more user input for the same displayed item or another item (e.g., of the one or more advertised items). If there is no recommendation at decision block 435, the process flow 400 proceeds according to the No arrow to decision block 440.

At decision block 440, the inferential system observes whether the user navigates toward content other than the advertised item. If this navigation is present, the process flow 400 proceeds according to the Yes arrow to block 441. At block 441, the inferential system scores criteria for a user interest level for the advertised item. Scoring by the inferential system can be performed according to equation 1.

Score=ΣO₁H₁+O₂H₂+ . . . +O_{X}H_{X} Equation 1:

At block 442, the inferential system classifies user interest (e.g. as high, medium, or low) based on the score. The process flow 400 then proceeds according to block 410 to gather more user input for the same displayed item or another item (e.g., of the one or more advertised items). If this navigation is not present at decision block 440, the process flow 400 proceeds directly to block 410. In a non-limiting embodiment, the user behavior navigation can be to a same (or partner) website.

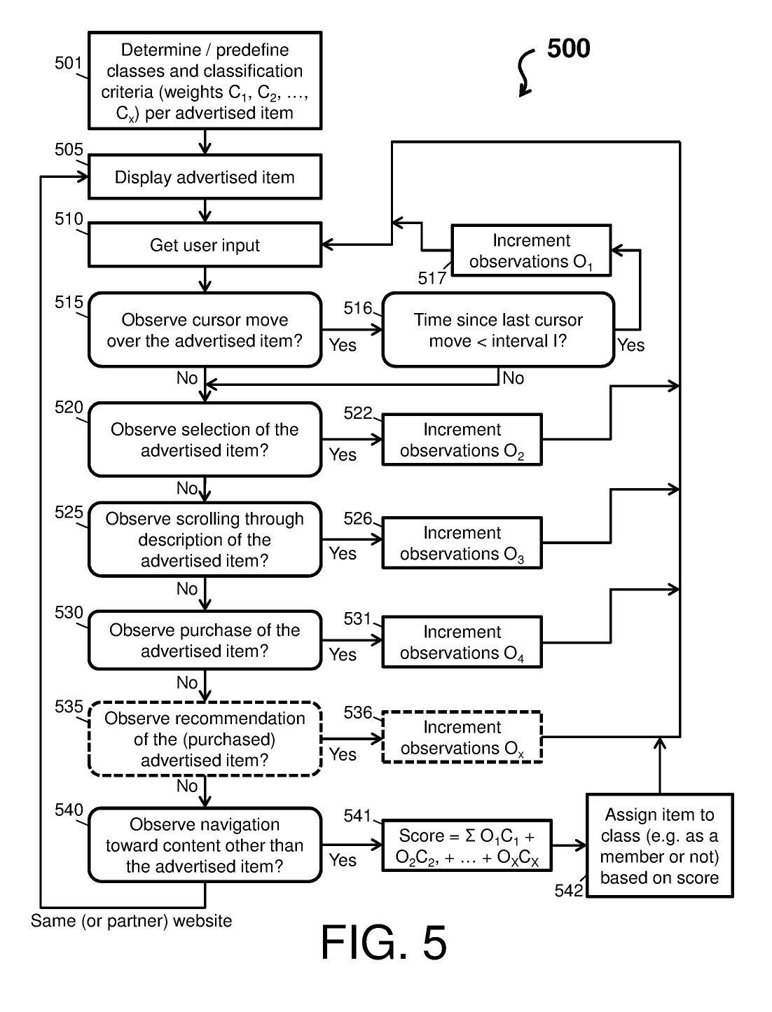

Turning now to FIG. 5, a process flow 500 of an inferential system for scoring criteria for item classification is depicted in accordance with one or more embodiments of the present invention. The process flow 500 begins at block 501, where the inferential system determines (and/or utilizes predefined) classes and classifications (weights C₁, C₂, . . . , Cₓ) per advertised item of one or more advertised items. At block 505, the inferential system displays one or more advertised items. The inferential system, upon displaying the one or more advertised items, monitors user activity with respect to those items. For instance, at block 510, the inferential system gets user input. The inferential system, by monitoring user activity, can sequentially and/or simultaneously execute one or more inquiries that result in scoring criteria for item classification for each of the one or more advertised items.

At decision block 515, the inferential system observes whether there is a cursor movement over a displayed advertised item (e.g., the one or more advertised items). If there is movement, the process flow 500 proceeds according to the Yes arrow to decision block 516. At decision block 516, the inferential system determines whether a time since a last cursor move is less than an interval I. If the last cursor move is less than the interval I, the process flow 500 proceeds according to the Yes arrow to block 517. At block 517, the inferential system increments a first observation count O₁, and the process flow 500 proceeds according to block 510 to gather more user input for the same displayed item or another item (e.g., of the one or more advertised items). If there is no movement or if the last cursor move is not less than the interval I at decision block 515, the process flow 500 proceeds according to the corresponding No arrows to decision block 520.

At decision block 520, the inferential system observes whether there is a selection of the displayed advertised item. If there is a selection, the process flow 500 proceeds according to the Yes arrow to block 522. At block 522, the inferential system increments a second observation count O₂, and the process flow 500 proceeds according to block 510 to gather more user input for the same displayed item or another item (e.g., of the one or more advertised items). If there is no selection at decision block 520, the process flow 500 proceeds according to the No arrow to decision block 525.

At decision block 525, the inferential system observes whether there is a scrolling through the description of the displayed advertised item. If there is a scrolling, the process flow 500 proceeds according to the Yes arrow to block 526. At block 526, the inferential system increments a third observation count O₃, and the process flow 500 proceeds according to block 510 to gather more user input for the same displayed item or another item (e.g., of the one or more advertised items). If there is no scrolling at decision block 525, the process flow 500 proceeds according to the No arrow to decision block 530.

At decision block 550, the inferential system observes whether there is a purchase of the displayed advertised item. If there is a purchase, the process flow 500 proceeds according to the Yes arrow to block 531. At block 531, the inferential system increments a fourth observation count O₄, and the process flow 500 proceeds according to block 510 to gather more user input for the same displayed item or another item (e.g., of the one or more advertised items). If there is no purchase at decision block 530, the process flow 500 proceeds according to the No arrow to decision block 535 and/or block 540. That is, decision block 535 is representative of a plurality of inquires that can be included in the process flow 500 in addition to and/or in lieu of the inquiries discussed herein. Thus, decision block 535 and block 536 are shown as dashed-lined to represent the scalability of the process flow 500 (e.g., embodiments herein demonstrate real-world scalability more than may be achieved using direct item-item relationship determinations).

At decision block 535, the inferential system observes whether there is a recommendation, posted by the user, of the advertised item. In a non-limiting embodiment, this recommendation can be in conjunction with the purchase of block 530 during a subsequent data gathering loop. If there is a recommendation, the process flow 500 proceeds according to the Yes arrow to block 536. At block 536, the inferential system increments at least one subsequent observation count Oₓ, and the process flow 500 proceeds according to block 510 to gather more user input for the same displayed item or another item (e.g., the one or more advertised items). If there is no recommendation at decision block 535, the process flow 500 proceeds according to the No arrow to block 540.

At decision block 540, the inferential system observes whether there user behavior navigates toward content other than the advertised item. If this navigation is present, the process flow 500 proceeds according to the Yes arrow to block 541. At block 541, the inferential system scores criteria for item classification for the advertised item. Scoring by the inferential system can be performed according to equation 2.

Score=ΣO₁C₁+O₂C₂+ . . . +O_{X}C_{X} Equation 2:

At block 542, the inferential system assigns the advertised item to an item class (e.g. as a member or not) based on the score. The process flow 500 then proceeds according to block 510 to gather more user input for the same displayed item or another item (e.g., the one or more advertised items). If this navigation is not present at decision block 540, the process flow 500 proceeds directly to block 510. In a non-limiting embodiment, the user behavior navigation can be to a same (or partner) website.

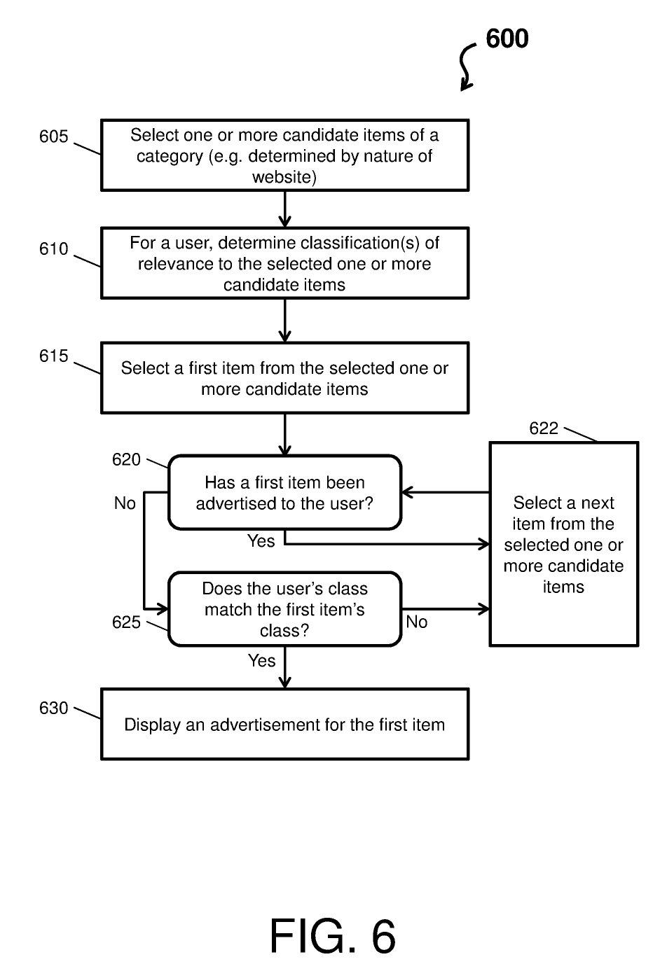

Turning now to FIG. 6, a process flow 600 of an inferential system for selecting one or more items to advertise is depicted in accordance with one or more embodiments of the present invention. The process flow 600 begins at block 605, where the inferential system selects one or more candidate items of a category (e.g. determined by the nature of the website). At block 610, the inferential system, for a user, determines classification(s) of relevance to the selected one or more candidate items (e.g. in accordance with the item classifications as described with respect to FIG. 5). At block 615, the inferential system selects a first item from the selected one or more candidate items.

At decision block 620, the inferential system determines whether a first item has been advertised to the user. If the first item has been advertised, the process flow 600 proceeds according to the Yes arrow to block 622. At block 622, the inferential system selects a next item from the selected one or more candidate items and then the process flow returns to decision block 620. This loop between decision block 620 and block 622 can repeat until an item that has not been advertised is found or until the selected one or more candidate items have been exhausted. If the first item been has not been advertised, the process flow 600 proceeds according to the No arrow to block 625.

At decision block 626, the inferential system determines whether the user's class matches the first item's class (e.g. in accordance with a combined classification as described in paragraph 22). If the user's class does not match the first item's class, the process flow 600 proceeds according to the No arrow to block 622. This loop between decision blocks 620 and 625 and block 622 can repeat until an item that has not been advertised and that matches the user's class is found or until the selected one or more candidate items have been exhausted. If the user's class does match the first item's class, the process flow 600 proceeds according to the Yes arrow to block 630. At block 630, the inferential system displays an advertisement for the first item. Note that the inferential system can display the advertisement for any item determined from decision blocks 620 and 625.

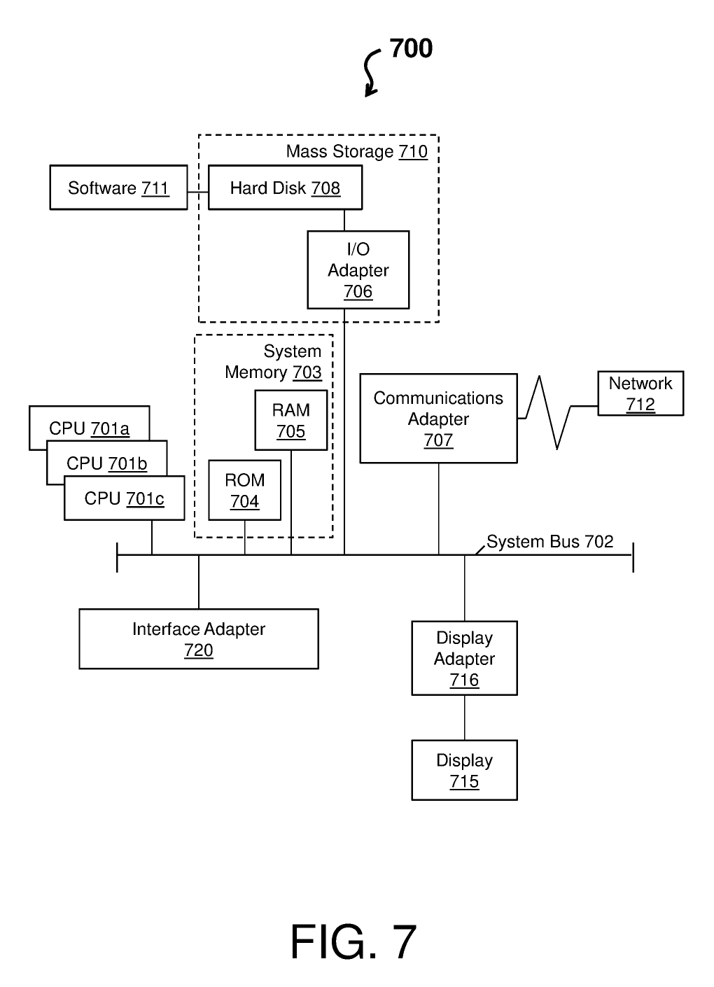

Referring now to FIG. 7, there is shown an embodiment of a processing system 700 for implementing the teachings herein. In this embodiment, the processing system 700 has one or more central processing units (CPU(s)) 701a, 701b, 701c, etc. (collectively or generically referred to as processor(s) 701). The processors 701, also referred to as processing circuits, are coupled via a system bus 702 to system memory 703 and various other components. The system memory 703 can include a read only memory (ROM) 704 and a random access memory (RAM) 705. The ROM 704 is coupled to the system bus 702 and may include a basic input/output system (BIOS), which controls certain basic functions of the processing system 700. The RAM is read-write memory coupled to the system bus 702 for use by the processors 701.

FIG. 7 further depicts an input/output (I/O) adapter 706 and a communications adapter 707 coupled to the system bus 702. The I/O adapter 706 may be a small computer system interface (SCSI) adapter that communicates with a hard disk 708 and/or any other similar component. The I/O adapter 706 and the hard disk 708 are collectively referred to herein as a mass storage 710. A software 711 for execution on the processing system 700 may be stored in the mass storage 710. The mass storage 710 is an example of a tangible storage medium readable by the processors 701, where the software 711 is stored as instructions for execution by the processors 701 to perform a method, such as the process flows of FIGS. 1-6. A communications adapter 707 interconnects the system bus 702 with a network 712, which may be an outside network, enabling the processing system 700 to communicate with other such systems. A display (e.g., screen, a display monitor) 715 is connected to the system bus 702 by a display adapter 716, which may include a graphics controller to improve the performance of graphics intensive applications and a video controller. In one embodiment, the adapters 706, 707, and 716 may be connected to one or more I/O buses that are connected to the system bus 702 via an intermediate bus bridge (not shown). Suitable I/O buses for connecting peripheral devices such as hard disk controllers, network adapters, and graphics adapters typically include common protocols, such as the Peripheral Component Interconnect (PCI). Additional input/output devices are shown as connected to the system bus 702 via an interface adapter 720 and the display adapter 716. A keyboard, a mouse, a speaker, etc. can be interconnected to the system bus 702 via the interface adapter 720, which may include, for example, a Super I/O chip integrating multiple device adapters into a single integrated circuit.

Thus, as configured in FIG. 7, the processing system 700 includes processing capability in the form of the processors 701, and, storage capability including the system memory 703 and the mass storage 710, input means such as the keyboard and the mouse, and output capability including the speaker and the display 715. In one embodiment, a portion of the system memory 703 and the mass storage 710 collectively store an operating system, such as the z/OS or AIX operating system from IBM Corporation, to coordinate the functions of the various components shown in FIG. 7.

In embodiments, item classifications can be determined by one or more users (e.g., software designers or administrators) and/or by one or more autonomous agents that analyze product or service descriptions and reviews, product or service technical documentation, images or other descriptive information related to a product or service, or user behavior with respect to other advertised items that have been previously classified. An autonomous agent suitable for use in embodiments can rely on natural language processing, machine learning, entity analytics, name recognition, heuristics, or other analytics processing to classify items. Item classification may include a combination of autonomous classifications and item classifications determined by the one or more users. Item classifications, and corresponding user classifications, can include classifications not explicitly described in the examples provided herein, which are merely illustrative and not intended to be limiting.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, configuration data for integrated circuitry, or either source code or object code written in any combination of one or more programming languages, including an object oriented programming language such as Smalltalk, C++, or the like, and procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one more other features, integers, steps, operations, element components, and/or groups thereof.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A processor-implemented method for determining interest levels with respect to a plurality of items displayable by a user interface, the processor-implemented method comprising:
determining, by a processor, a user classification of a user browsing via the user interface at least a portion of the plurality of items;
determining, by the processor, a first interest level in a first item of the plurality of items, the first item being associated with a first category;
determining, by the processor, a second interest level in a second item of the plurality of items, the second item being associated with a second category;
determining, by the processor, a first relationship between the first item and a third item;
determining, by the processor, a second relationship between the second item and the third item; and
determining, by the processor, a third interest level in a third item of the plurality of items based on the user classification, the first relationship, and the second relationship.

2. The processor-implemented method of claim 1, wherein the processor utilizes item categories when determining the user classifications.

3. The processor-implemented method of claim 1, wherein determining the first interest level comprises observing user behavior within the user interface with respect to the first item.

4. The processor-implemented method of claim 1, wherein the at least the portion of the plurality of items is advertised by one or more primary advertisers that are not identical to a subsequent advertiser of the third item.

5. The processor-implemented method of claim 1, wherein the first category and the second category are disjointed categories.

6. The processor-implemented method of claim 5, wherein the disjointed categories represent two or more dissimilar merchants and websites.

7. The processor-implemented method of claim 1, wherein the third item is associated with a third category, and
wherein the first relationship and the second relationship are determined across the first and second categories with respect to the third category.

8. A computer program product for determining interest levels with respect to a plurality of items displayable by a user interface, the computer program product comprising a computer readable storage medium having program instructions embodied therewith, the program instructions executable by a processor to cause the processor to:
determine a user classification of a user browsing via the user interface at least a portion of the plurality of items;
determine a first interest level in a first item of the plurality of items, the first item being associated with a first category;
determine a second interest level in a second item of the plurality of items, the second item being associated with a second category;
determine a first relationship between the first item and a third item;
determine a second relationship between the second item and the third item; and
determine a third interest level in a third item of the plurality of items based on the user classification, the first relationship, and the second relationship.

9. The computer program product of claim 8, wherein the processor utilizes item categories when determining the user classifications.

10. The computer program product of claim 8, wherein determining the first interest level comprises observing user behavior within the user interface with respect to the first item.

11. The computer program product of claim 8, wherein the at least the portion of the plurality of items is advertised by one or more primary advertisers that are not identical to a subsequent advertiser of the third item.

12. The computer program product of claim 8, wherein the first category and the second category are disjointed categories.

13. The computer program product of claim 12, wherein the disjointed categories represent two or more dissimilar merchants and websites.

14. The computer program product of claim 8, wherein the third item is associated with a third category, and
wherein the first relationship and the second relationship are determined across the first and second categories with respect to the third category.

15. A system for determining interest levels with respect to a plurality of items displayable by a user interface, comprising a processor and a memory storing program instructions thereon, the program instructions executable by a processor to cause the system to:
determine a user classification of a user browsing via the user interface at least a portion of the plurality of items;
determine a first interest level in a first item of the plurality of items, the first item being associated with a first category;
determine a second interest level in a second item of the plurality of items, the second item being associated with a second category;
determine a first relationship between the first item and a third item;
determine a second relationship between the second item and the third item; and
determine a third interest level in a third item of the plurality of items based on the user classification, the first relationship, and the second relationship.

16. The system of claim 15, wherein the processor utilizes item categories when determining the user classifications.

17. The system of claim 15, wherein determining the first interest level comprises observing user behavior within the user interface with respect to the first item.

18. The system of claim 15, wherein the at least the portion of the plurality of items is advertised by one or more primary advertisers that are not identical to a subsequent advertiser of the third item.

19. The system of claim 15, wherein the first category and the second category are disjointed categories.

20. The system of claim 19, wherein the disjointed categories represent two or more dissimilar vendors and web sites.
